(19) United States
(12) Patent Application Publication
(10) Pub. No.: US 2019/0322839 A1
(43) Pub. Date: Oct. 24, 2019

(54) RESIN MOLDED PRODUCT

(71) Applicant: AICELLO CORPORATION, Toyohashi-shi, Aichi (JP)

(72) Inventors: Shiro SAWADA, Toyohashi-shi, Aichi (JP); Tomohiro NIIMI, Toyohashi-shi, Aichi (JP)

(21) Appl. No.: 16/341,854

(22) PCT Filed: Oct. 23, 2017
(86) PCT No.: PCT/JP2017/038103

§ 371 Date: Apr. 12, 2019

(30) Foreign Application Priority Data
Oct. 24, 2016 (JP) 2016-208202

(51) Int. Cl. C08K 5/3475; C08K 5/17; C08K 5/098; C08K 5/09; C08J 5/18; B32B 27/18; B32B 27/32

(52) U.S. Cl. CPC C08K 5/3475; C08K 5/175; C08K 5/098; C08K 5/09; B32B 2264/104; B32B 27/18; B32B 27/32; C08K 2201/005; C08J 2323/06; C08J 5/18

(57) ABSTRACT

A resin molded product has a resin layer 1 that contains an ammonium salt of carboxylic acid with an average particle size of 20 μm or larger. The resin molded product can achieve long-term anticorrosive effect on a wide range of articles such as iron castings, steel sheets, and galvanized steel sheets.

### TECHNICAL FIELD

The present invention relates to a resin molded product.

### BACKGROUND ART

As described in Patent Literature 1, corrosion inhibitor compositions, each containing a volatile corrosion inhibitor in the form of ammonium salt of alkyl dicarboxylic acid and a water-soluble corrosion inhibitor, as well as corrosion inhibitor resin compositions, each prepared from a thermoplastic resin containing any such corrosion inhibitor composition, are known.

Also, as described in Patent Literature 2, packaging containers for metal products, each formed by a multi-layer sheet consisting of a base resin sheet that has been directly bonded, by means of thermal lamination, with a film containing a volatile corrosion inhibitor and then post-molded so that the resin film containing the volatile corrosion inhibitor faces the metal product side, are known.

### BACKGROUND ART LITERATURE

### Patent Literature

Patent Literature 1: Japanese Patent Laid-open No. 2007-308726
Patent Literature 2: Japanese Patent Laid-open No. 2007-230568

### SUMMARY OF THE INVENTION

### Problems to be Solved by the Invention

Adopting a laminate sheet consisting of two layers as an anticorrosive film for storing metal products, etc., helps the anticorrosive effect of the film last longer; if, however, an anticorrosive film with a resin layer containing a volatile corrosion inhibitor and a water-soluble corrosion inhibitor is used, according to the invention described in Patent Literature 1, for example, it becomes difficult to control the generation of the volatile corrosion inhibitor during use, which consequently makes it difficult to generate the corrosion inhibitor over a long period of time.

Also, as described in Patent Literature 2, overlaying one side of a sheet containing a volatile corrosion inhibitor with a base material sheet has been known as a way to help the anticorrosive effect last longer.

Still, however, these sheets are unable to maintain their anticorrosive property over a long period of time, and there is a need, today, to achieve long-term anticorrosive effect on a wide range of articles such as iron castings, steel sheets, and galvanized steel sheets.

### Means for Solving the Problems

The inventor of the present invention studied in earnest to solve the aforementioned problems, and made the present invention after discovering that they could be solved by the following means:

1. A resin molded product having resin layer 1 that contains an ammonium salt of carboxylic acid with an average particle size of 20 μm or larger.

2. A resin molded product according to 1, wherein resin layer 1 contains a metal salt of carboxylic acid.

3. A resin molded product according to 1 or 2, wherein resin layer 1 contains one or more types of substances selected from carboxylic acid, benzotriazole-based compound, and tolyltriazole-based compound.

4. A resin molded product according to any one of 1 to 3, which is further overlaid with a base material layer.

5. A resin molded product according to 4, wherein the base material layer contains one or more types of substances selected from metal salt of nitrous acid, carboxylic acid, benzotriazole-based compound, tolyltriazole-based compound, and metal salt of carboxylic acid.

6. A resin molded product according to any one of 1 to 5, which is a sheet-like object or bag-like object.

### Effects of the Invention

According the resin molded product that contains an ammonium salt of carboxylic acid having a specific particle size, as proposed by the present invention, a container, sheet-like object, or bag-like object constituted at least partially by this molded product, when it is used to store metal products or other products subject to corrosion, or is packed together with such products, can maintain anticorrosive effect for a long period of time. This allows for reliable, long-term inhibition of corrosion on metal products during transport, storage, etc.

### MODE FOR CARRYING OUT THE INVENTION

The present invention is a resin molded product that includes resin layer 1, and the invention also permits providing resin layer 2 and, depending on the situation, a base material layer.

Modes of the present invention are explained below.

(Ammonium Salt of Carboxylic Acid)

The ammonium salt of carboxylic acid under the present invention may be an ammonium salt of aliphatic carboxylic acid or ammonium salt of aromatic carboxylic acid.

Ammonium salts of carboxylic acids that may be used include ammonium salts of butyric acid, isobutylic acid, methacrylic acid, valeric acid, caproic acid, caprylic acid, capric acid, lauric acid, tridecylic acid, myristic acid, palmitic acid, stearic acid, sorbic acid, oleic acid, oleylic acid, isohexanic acid, 2-methyl pentanoic acid, 2-ethyl butanoic acid, isoheptanoic acid, isooctanoic acid, 2-ethyl hexanoic acid, isononanoic acid, isodecanoic acid, 2-propyl heptanoic acid, isoundecanoic acid, isododecanoic acid, 2-butyl octanoic acid, oxalic acid, malonic acid, succinic acid, glutaric acid, adipic acid, pimelic acid, suberic acid, azelaic acid, sebacic acid, undecane dicarboxylic acid, dodecane dioic acid, and other aliphatic carboxylic acids, as well as ammonium salts of benzoic acid, amino benzoic acid, salicylic acid, p-tert-butyl benzoic acid, o-sulfobenzoic acid, 1-naphthoic acid, 2-naphthoic acid, phthalic acid, isophthalic acid, terephthalic acid, cinnamic acid, and other aromatic carboxylic acids, of which any one or more types may be adopted.

Under the present invention, adopting an ammonium salt of aromatic carboxylic acid, rather than ammonium salt of aliphatic carboxylic acid, may be preferable, particularly when the molded product has only resin layer 1, from the viewpoint of realizing anticorrosive property over a long period of time.

Also, adopting an ammonium salt of aromatic carboxylic acid is preferable in terms of product appearance, because some ammonium salts of aliphatic carboxylic acids may bleed out onto the surface of the resin molded product and degrade the appearance of the product as a result.

The content of the ammonium salt of carboxylic acid is preferably 0.01 to 10 parts by weight, or more preferably 0.1 to 9 parts by weight, or yet more preferably 0.2 to 6 parts by weight, relative to 100 parts by weight of the resin layer in which it is contained. If the content is less than 0.01 parts by weight, realizing sufficient corrosion inhibition property becomes difficult, while a content exceeding 10 parts by weight makes molding difficult.

The ammonium salt of carboxylic acid is contained in resin layer 1 in the form of particles, and their average particle size is 20 μm or larger, or preferably 20 to 400 μm, or more preferably 20 to 200 μm, or yet more preferably 20 to 100 μm. It should be noted that this average particle size is obtained based on the long diameters of particles of the ammonium salt of carboxylic acid contained in the resin layer, excluding those particles whose long diameter is 10 μm or smaller. This is because fine particles may not contribute much to the long-term maintenance of anticorrosive property, which means such fine particles are small in number or particles of a certain range of sizes are contained by a large number.

Additionally, the maximum particle size of the ammonium salt of carboxylic acid contained in resin layer 1 is preferably 5000 μm or smaller, or more preferably 3000 μm or smaller, or yet more preferably 500 μm or smaller. If the particle size of the ammonium salt of carboxylic acid exceeds 5000 μm, the strength of the resin molded product may decrease or the metal product may be tainted by drop-out of particles, etc. The maximum particle size represents the largest of the particle sizes measured on 1,000 particles.

So long as the average particle size and/or maximum particle size is/are within the aforementioned ranges, the particles of ammonium salt of carboxylic acid form convex parts on the surface of resin layer 1 in a state covered by the resin. Presence of these convex parts allows for generation of more corrosion inhibiting gas, which contributes to the improvement of anticorrosive property. Additionally, these convex parts on the film surface have the effect of preventing the film from sticking to the article, etc., to be prevented from corroding, while also preventing the particles of ammonium salt of carboxylic acid from directly contacting the article and thereby tainting the surface of the article.

However, a series of steps from compounding particles of ammonium salt of carboxylic acid into a resin by which to constitute the resin layer, to melting/kneading the resin and molding it into sheet shape, for example, may crush the powder of ammonium salt of carboxylic acid and cause its average particle size to decrease compared to before compounding. For this reason, the aforementioned average particle size under the present invention is a value relating to the ammonium salt of carboxylic acid contained in resin layer 1 after resin layer 1 has been formed.

When an ammonium salt of carboxylic acid having these specific particle sizes is contained, anticorrosive effect can be maintained over a long period of time in a stable manner because the generating amount of anticorrosive gas is controlled.

(Metal Salt of Carboxylic Acid)

The metal salt of carboxylic acid under the present invention may be a metal salt of aliphatic carboxylic acid or metal salt of aromatic carboxylic acid.

Metal salts of carboxylic acids of these types include metal salts such as sodium salts, potassium, calcium, magnesium, and the like, of aliphatic carboxylic acids such as isobutylic acid, methacrylic acid, valeric acid, caproic acid, caprylic acid, capric acid, lauric acid, tridecylic acid, myristic acid, palmitic acid, stearic acid, sorbic acid, oleic acid, oleylic acid, isohexanic acid, 2-methyl pentanoic acid, 2-ethyl butanoic acid, isoheptanoic acid, isooctanoic acid, 2-ethyl hexanoic acid, isononanoic acid, isodecanoic acid, 2-propyl heptanoic acid, isoundecanoic acid, isododecanoic acid, 2-butyl octanoic acid, oxalic acid, malonic acid, succinic acid, glutaric acid, adipic acid, pimelic acid, suberic acid, azelaic acid, sebacic acid, undecane dicarboxylic acid, dodecane dioic acid, and the like, as well as aromatic carboxylic acids such as benzoic acid, amino benzoic acid, salicylic acid, p-tert-butyl benzoic acid, o-sulfobenzoic acid, 1-naphthoic acid, 2-naphthoic acid, phthalic acid, isophthalic acid, terephthalic acid, cinnamic acid, and the like, any one or more types of which may be adopted.

The content of the metal salt of carboxylic acid is preferably 0.001 to 10 parts by weight, or more preferably 0.01 to 5 parts by weight, relative to 100 parts by weight of the resin layer in which it is contained. If the content is less than 0.001 parts by weight, realizing sufficient anticorrosive property becomes difficult, while a content exceeding 10 parts by weight not only makes molding difficult, but it also makes realization of long-term anticorrosive property difficult.

(Carboxylic Acid)

The carboxylic acid under the present invention may be an aliphatic carboxylic acid or aromatic carboxylic acid.

Carboxylic acids of these types include isobutylic acid, methacrylic acid, valeric acid, caproic acid, caprylic acid, capric acid, lauric acid, tridecylic acid, myristic acid, palmitic acid, stearic acid, sorbic acid, oleic acid, oleylic acid, isohexanic acid, 2-methyl pentanoic acid, 2-ethyl butanoic acid, isoheptanoic acid, isooctanoic acid, 2-ethyl hexanoic acid, isononanoic acid, isodecanoic acid, 2-propyl heptanoic acid, isoundecanoic acid, isododecanoic acid, 2-butyl octanoic acid, oxalic acid, malonic acid, succinic acid, glutaric acid, adipic acid, pimelic acid, suberic acid, azelaic acid, sebacic acid, undecane dicarboxylic acid, dodecane dioic acid, and other aliphatic carboxylic acids, as well as benzoic acid, amino benzoic acid, salicylic acid, p-tert-butyl benzoic acid, o-sulfobenzoic acid, 1-naphthoic acid, 2-naphthoic acid, phthalic acid, isophthalic acid, terephthalic acid, cinnamic acid, and other aromatic carboxylic acids, of which any one or more types may be adopted.

The content of any such carboxylic acid is preferably 0.001 to 10 parts by weight, or more preferably 0.01 to 5 parts by weight, relative to 100 parts by weight of the resin layer in which it is contained. If the content is less than 0.001 parts by weight, further improvement of anticorrosive property becomes difficult, while a content exceeding 10 parts by weight not only makes molding difficult, but it also makes realization of long-term anticorrosive property difficult.

(Benzotriazole-Based Compound and Tolyltriazole-Based Compound)

For the benzotriazole-based compound and tolyltriazole-based compound under the present invention, one or more types selected from benzotriazole, 4-methyl benzotriazole, 5-methyl benzotriazole, etc., may be adopted.

The content of any such benzotriazole-based compound and tolyltriazole-based compound is preferably 0.001 to 10 parts by weight, or more preferably 0.01 to 5 parts by weight, relative to 100 parts by weight of the resin layer in which it is contained. If the content is less than 0.001 parts by weight, further improvement of long-term anticorrosive property becomes difficult, while a content exceeding 10 parts by weight not only makes molding difficult, but it also makes realization of long-term anticorrosive property difficult.

(Metal Salt of Nitrous Acid)

For the metal salt of nitrous acid under the present invention, one or more types selected from sodium salt, potassium salt, calcium salt, magnesium salt, etc., of nitrous acids may be adopted.

The content of any such metal salt of nitrous acid is preferably 0.001 to 10 parts by weight, or more preferably 0.01 to 5 parts by weight, relative to 100 parts by weight of the resin layer in which it is contained. If the content is less than 0.001 parts by weight, further improvement of anticorrosive property becomes difficult, while a content exceeding 10 parts by weight not only makes molding difficult, but it also makes realization of long-term anticorrosive property difficult.

(Resin Layers 1 and 2)

For the resin by which to constitute each of the resin layers 1, 2, one or more types selected from polyolefin-based polymers, or specifically olefin homopolymers and/or copolymers using olefin monomers, may be selected and used independently for each layer.

Olefins (olefin monomers) that constitute polyolefin-based polymers include ethylene, propylene, 1-butene, 3-methyl-1-butene, 1-pentene, 3-methyl-1-pentene, 4-methyl-1-pentene, 1-hexene, 1-octene, etc. Accordingly, polyolefin-based polymers include ethylene-based polymers, propylene-based polymers, 1-butene-based polymers, 1-hexene-based polymers, 4-methyl-1-pentene-based polymers, etc. Any one of these types of polymers may be used alone, or two or more types may be combined. In other words, a polyolefin-based polymer may be a mixture of various types of polymers.

Among the above, ethylene-based polymers include ethylene homopolymers (polyethylenes) and copolymers of ethylene and other monomers (ethylene copolymers). Ethylene homopolymers include, for example, low-density polyethylenes (LDPE), linear low-density polyethylenes (L-LDPE), medium-density polyethylenes (MDPE), and high-density polyethylenes (HDPE).

Also, ethylene copolymers include ethylene/propylene copolymers, ethylene/1-butene copolymers, ethylene/1-pentene copolymers, ethylene/1-hexene copolymers, ethylene/1-octene copolymers, ethylene/4-methyl-1-pentene copolymers, etc.

It should be noted that, while the ethylene units contained in the ethylene copolymer (ethylene-derived constituent units) need only account for more than 50% (normally up to 99.999%) of all constituent units, they may account for 80 to 99.999%, or 90 to 99.995%, or even 99.0 to 99.990% of all constituent units, for example.

Also, propylene-based polymers include propylene homopolymers (polypropylenes) and copolymers of propylene and other monomers (propylene copolymers). Propylene copolymers include propylene/ethylene copolymers, propylene/1-butene copolymers, propylene/1-pentene copolymers, propylene/1-octene copolymers, etc.

It should be noted that, while the propylene units contained in the propylene copolymer (propylene-derived constituent units) need only account for more than 50% (normally up to 99.999%) of all constituent units, they may account for 80 to 99.999%, or 90 to 99.995%, or even 99.0 to 99.990% of all constituent units, for example.

Also, the polyolefin-based polymer may contain constituent units derived from monomers other than olefins, to the extent that the object of the present invention is not adversely affected. Monomers other than olefins include unsaturated carboxylic acids (acrylic acid, methacrylic acid, etc.), unsaturated carboxylic acid esters (methyl acrylate, ethyl acrylate, butyl acrylate, methyl methacrylate, ethyl methacrylate, butyl methacrylate, dimethyl maleate, diethyl maleate, etc.), vinyl esters (vinyl acetate, vinyl propionate, fumarate, maleic acid anhydride, maleic acid monoester, etc.), and the like. Of the foregoing, any one type may be used alone, or two or more types may be combined.

It should be noted that the constituent units contained in the polyolefin-based polymer, which are derived from monomers other than olefins, preferably account for no more than 40% (normally at least 0.001%) of all constituent units, if contained. For example, they may account for 0.001 to 25%, or 0.005 to 15%, or even 0.01 to 10% of all constituent units.

The density of the polyolefin-based resin is preferably 0.880 to 0.950 g/cm³ from the viewpoint of processability. Also, its melt flow rate (MFR) is preferably in a range of 1.0 to 10.0 g/10 min from the viewpoints of mechanical strength and processability, because when the resin has an appropriate viscosity at melt processing, the ammonium salt of carboxylic acid in granular state can be contained in and covered by the resin so that drop-out of the corrosion inhibitor from the resin molded product can be prevented.

Additionally, known additives to resins, such as anti-blocking agent (AB agent), lubricant, antioxidant, antistatic agent, UV-absorbing agent, and processability-improving agent, may be added to the resin layers 1, 2 to the extent that the effects of the present invention are not inhibited.

It should be noted that, according to the present invention, sufficient long-term anticorrosive property can be realized without compounding any ionomer resin or functional group-containing polyolefin resin into resin layer 1 or resin layer 2 for the purpose of retaining the corrosion inhibitor in the resin layer.

In addition, the thickness of resin layer 1 and that of resin layer 2 are each independently 30 to 500 μm, or preferably 30 to 200 μm.

Although the reason is unclear and specific results vary depending on the type of metal to be prevented from corroding, the present invention, while achieving a certain level of long-term anticorrosive property in a molded product constituted only by resin layer 1 that contains an ammonium salt of carboxylic acid alone, can provide a molded product offering greater long-term anticorrosive property when the resin layer simultaneously contains one or more types of substances selected from metal salt of carboxylic acid, carboxylic acid, benzotriazole-based compound, and tolyltriazole-based compound.

Also, long-term anticorrosive property can be improved further when resin layer 1 containing an ammonium salt of carboxylic acid is overlaid with resin layer 2 containing one or more types of substances selected from metal salt of aliphatic carboxylic acid, metal salt of nitrous acid, carboxylic acid, benzotriazole-based compound, and tolyltriazole-based compound.

Although a detailed mechanism is not yet identified, it is considered that adjusting the particle sizes of ammonium salt of carboxylic acid to a specific range allows for formation of convexes on the film surface and long-term anticorrosive effect is realized as a result.

(Base Material Layer)

The resin molded product proposed by the present invention may further have a base material layer provided on the surface on the resin layer 1 side and/or resin layer 2 side.

The base material layer is provided with the aims, among others, of adding strength as well as gas barrier property and water vapor barrier property to, and improving the feel and aesthetic look of, the molded product proposed by the present invention. For the material by which to constitute the base material layer, any material that does not inhibit the anticorrosive effect achieved by the resin layers 1, 2 may be adopted, and preferably the material has excellent adhesion to the resins constituting resin layer 1 and resin layer 2. So, for the material by which to constitute the base material layer, any of the aforementioned resins that can be used for resin layer 1 and resin layer 2, any resin having excellent adhesion to resin layer 1 and resin layer 2, or even woven fabric, nonwoven fabric, or paper, may be adopted.

If a resin is adopted, each resin layer may contain various known additives. Also, each resin layer may be porous or nonporous.

Regarding the method for forming such resin-based base material layer, the base material layer may be formed at the same time resin layer 1 and/or resin layer 2 is/are formed, or a method may be adopted whereby the base material layer is formed separately from resin layer 1 or resin layer 2 and then laid over it using a known means.

(Manufacture and Use of Resin Molded Product Having Resin Layer 1)

A resin molded product having resin layer 1 may be formed by any known means such as extrusion, inflation, vacuum molding or pressure molding, and have any desired shape such as film, sheet-like object, bag-like object, laminate sheet-like object, cylinder or box. It may be used so that its face on the resin layer 1 side is positioned on the inner side of the container or packaging sheet, or specifically on the side of the article to be stored or packed and thus prevented from rusting; conversely, it may be used, if resin layer 2 is provided, so that its face on the resin layer 2 side is positioned on the inner side of the container or packaging sheet, or specifically on the side of the article to be stored or packed and thus prevented from corroding.

It should be noted that, under the present invention, the average particle size of ammonium salt of carboxylic acid is within a specific range. Due to their nature, however, ammonium salts of carboxylic acids may be crushed and become smaller in average particle size as they are added to and kneaded with resins and also in the molding step; accordingly, caution must be exercised to make sure the specific average particle size specified in the present invention is achieved after molding.

So long as an ammonium salt of carboxylic acid having this specific particle size is contained, the generating amount of anticorrosive gas can be controlled, and consequently anticorrosive effect can be maintained over a long period of time in a stable manner.

Furthermore, adopting two resin layers helps maintain high anticorrosive effect over a long period of time in a more stable manner, without adding a carboxylic acid-modified polyolefin-based polymer, wax, nonionic surface-active agent, inorganic porous medium, or other agent used for sustained release of corrosion inhibitor, because moisture permeates slowly into resin layer 2 or 1 from the surface and thus anticorrosive gas also generates slowly.

Also, the scope of articles to be prevented from corroding covers a wide range of items such as iron castings, steel sheets, and galvanized steel sheets.

### Examples

The present invention is explained more specifically using the examples and comparative examples provided below.

It should be noted that the examples each represent only one embodiment of the present invention and the present invention is not limited to these examples.

Each of the corrosion inhibition components shown in Table 1 was added to 100 parts by weight of a low-density polyethylene (Sumikasen F200 manufactured by Sumitomo Chemical, density=0.924/cm³, MFR=2.0 g/10 min), and the ingredients were stirred and mixed by hand, to prepare each molding compound. Using the obtained compounds, tubular films were produced by an inflation extrusion molding machine at a molding temperature of 150° C. For molding, a single-layer machine was used in Examples 1 to 11 and Comparative Examples 1 to 9, while a double-layer machine was used in Examples 12 to 17 to achieve two layers of an identical thickness.

⊚ Corrosion Inhibition Test

A. [Corrosion Inhibition Test Using Anticorrosive Film]

Each test piece as specified in [C] below was suspended from a nylon fishing line in a frame of 100 mm long×100 mm wide×150 mm high in size, and the frame was gusset-sealed with each produced film.

This test setup was left for each period in each test environment as specified in [B] below, after which the condition of corrosion formation on the surface was evaluated based on the evaluation method in [D] below.

B. [Test Environments]
25° C., 70% RH: 4 hours
50° C., 95% RH: 4 hours
Transition time between settings: 2 hours, for a total of 12 hours per cycle Evaluations
Medium-term effect: 3 days (6 cycles)
Long-term effect: 7, 14 days (14, 28 cycles)

C. [Test Pieces]
Iron casting (JIS G 5501), size: 030 mm×8 mm
Steel sheet (JIS G 3141), size: 1.2 mm×30 mm×50 mm Galvanized steel sheet (JIS H 8610), size: 1.4 mm×30 mm×50 mm

D. [Corrosion Inhibition Evaluation Criteria]

⊚: No corrosion or discoloration

◯: Spot corrosion or slight discoloration

Δ: corrosion or discoloration of less than 10% of the test piece by area

X: Corrosion or discoloration of 10% or more but less than 50% of the test piece by area

XX: Corrosion or discoloration of 50% or more of the test piece by area

[Measuring Condition for Average Particle Size of Ammonium Salt of Carboxylic Acid]

Resin layer 1 was photographed using a LEICA DFC295 stereoscopic microscope, and measurement was performed based on the photographed data.

It should be noted that, since particles of 10 μm or smaller in particle size were not measured, the term “average particle size” as it is used in the present invention represents a value obtained by the formula below based on a population of 1,000 particles whose long diameter exceeds 10 μm.

Average particle size=(Total sum of long diameters of particles larger than 10 μm)/Number of particles

TABLE 1

| | | | | Average grain | Maximum grain | |
|---|---|---|---|---|---|---|
| | | | | size of | size of | |
| | Resin layer 1 | Resin layer 2 | Thickness | ammonium salt | ammonium salt | |
| Example 1 | Ammonium benzoate (1 part) | | 100 μm | 21 μm | 45 | μm |
| Example 2 | Ammonium benzoate (1 part) | | 100 μm | 28 μm | 420 | μm |
| Example 3 | Ammonium benzoate (0.1 parts) | | 100 μm | 28 μm | 420 | μm |
| Example 4 | Ammonium benzoate (6 parts) | | 100 μm | 28 μm | 420 | μm |
| Example 5 | Ammonium benzoate (1 part) | | 100 μm | 200 μm | 1500 | μm |
| Example 6 | Ammonium benzoate (1 part) | | 100 μm | 400 μm | 3000 | μm |
| Example 7 | Ammonium benzoate (1 part) | | 60 μm | 28 μm | 420 | μm |
| Example 8 | Ammonium benzoate (1 part) | | 200 μm | 28 μm | 420 | μm |
| Example 9 | Ammonium benzoate (1 part) + Sodium sebacate (1 part) | | 100 μm | 28 μm | 420 | μm |
| Example 10 | Ammonium benzoate (1 part) + Benzoic acid (1 part) | | 100 μm | 28 μm | 420 | μm |
| Example 11 | Ammonium benzoate (1 part) + Sodium sebacate (1 part) + | | 100 μm | 28 μm | 420 | μm |
| | Benzotriazole (1 part) | | | | | |
| Example 12 | Ammonium benzoate (1 part) | Sodium sebacate (1 part) | 100 μm | 28 μm | 420 | μm |
| Example 13 | Ammonium benzoate (1 part) | Sodium sebacate (0.2 parts) | 100 μm | 28 μm | 420 | μm |
| Example 14 | Ammonium benzoate (0.1 parts) | Sodium sebacate (1 part) | 100 μm | 28 μm | 420 | μm |
| Example 15 | Ammonium benzoate (1 part) | Sodium caprylate (1 part) | 100 μm | 28 μm | 420 | μm |
| | Sodium p-tert-butyl | | | | | |
| | benzoate (1 part) | | | | | |
| Example 16 | Ammonium adipate (1 part) | Sodium sebacate (1 part) | 100 μm | 28 μm | 420 | μm |
| | | Sodium nitrite (1 part) | | | | |
| Example 17 | Ammonium adipate (1 part) | Sodium sebacate (1 part) | 100 μm | 28 μm | 420 | μm |
| | Benzotriazole (1 part) | Benzoic acid (1 part) | | | | |

| | | | | | |
|---|---|---|---|---|---|
| Comparative Example 1 | Ammonium benzoate (1 part) | 100 μm | 13 μm | 20 | μm |
| Comparative Example 2 | Ammonium benzoate (0.1 parts) | 100 μm | 13 μm | 20 | μm |
| Comparative Example 3 | Ammonium benzoate (6 parts) | 100 μm | 13 μm | 20 | μm |
| Comparative Example 4 | Ammonium benzoate (1 part) | 60 μm | 13 μm | 20 | μm |
| Comparative Example 5 | Ammonium benzoate (1 part) | 200 μm | 13 μm | 20 | μm |
| Comparative Example 6 | Ammonium benzoate (1 part) + Sodium sebacate (1 part) | 100 μm | 13 μm | 20 | μm |

| | | | | |
|---|---|---|---|---|
| Comparative Example 7 | Sodium sebacate (1 part) | 100 μm | — | — |
| Comparative Example 8 | Benzotriazole (1 part) | 100 μm | — | — |
| Comparative Example 9 | Not added. | 100 μm | — | — |

| | Iron casting | | | Steel sheet | | | Galvanized steel sheet | | |
|---|---|---|---|---|---|---|---|---|---|
| | 3 days | 7 days | 14 days | 3 days | 7 days | 14 days | 3 days | 7 days | 14 days |
| Example 1 | ⊚ | ◯ | X | ⊚ | ⊚ | ◯ | ⊚ | ◯ | Δ |
| Example 2 | ⊚ | ◯ | X | ⊚ | ⊚ | ◯ | ⊚ | ◯ | Δ |
| Example 3 | ⊚ | X | XX | ⊚ | ◯ | Δ | ⊚ | Δ | X |
| Example 4 | ⊚ | ⊚ | Δ | ⊚ | ⊚ | ⊚ | ⊚ | ⊚ | ◯ |
| Example 5 | ⊚ | Δ | X | ⊚ | ⊚ | ◯ | ⊚ | ◯ | Δ |
| Example 6 | ⊚ | Δ | X | ⊚ | ⊚ | ◯ | ⊚ | ◯ | Δ |
| Example 7 | ⊚ | Δ | X | ⊚ | ⊚ | ◯ | ⊚ | ◯ | Δ |
| Example 8 | ⊚ | ⊚ | Δ | ⊚ | ⊚ | ⊚ | ⊚ | ⊚ | Δ |
| Example 9 | ⊚ | ⊚ | Δ | ⊚ | ⊚ | ⊚ | ⊚ | ⊚ | Δ |
| Example 10 | ⊚ | ⊚ | X | ⊚ | ⊚ | ⊚ | ⊚ | ◯ | Δ |
| Example 11 | ⊚ | ⊚ | Δ | ⊚ | ⊚ | ⊚ | ⊚ | ⊚ | ⊚ |
| Example 12 | ⊚ | ⊚ | ⊚ | ⊚ | ⊚ | ⊚ | ⊚ | ⊚ | ◯ |
| Example 13 | ⊚ | ⊚ | ⊚ | ⊚ | ⊚ | ⊚ | ⊚ | ⊚ | ◯ |
| Example 14 | ⊚ | ◯ | Δ | ⊚ | ⊚ | ◯ | ⊚ | ◯ | ◯ |
| Example 15 | ⊚ | ⊚ | ⊚ | ⊚ | ⊚ | ⊚ | ⊚ | ⊚ | ◯ |
| Example 16 | ⊚ | ⊚ | ⊚ | ⊚ | ⊚ | ⊚ | ⊚ | ⊚ | ◯ |
| Example 17 | ⊚ | ⊚ | ⊚ | ⊚ | ⊚ | ⊚ | ⊚ | ⊚ | ⊚ |
| Comparative Example 1 | ◯ | X | XX | ⊚ | ◯ | Δ | ⊚ | Δ | X |
| Comparative Example 2 | Δ | XX | XX | ⊚ | Δ | X | ⊚ | X | X |
| Comparative Example 3 | ⊚ | Δ | X | ⊚ | ⊚ | ◯ | ⊚ | ⊚ | Δ |
| Comparative Example 4 | Δ | X | XX | ⊚ | ◯ | Δ | ⊚ | Δ | X |
| Comparative Example 5 | ⊚ | Δ | X | ⊚ | ⊚ | ◯ | ⊚ | ◯ | Δ |
| Comparative Example 6 | ⊚ | ◯ | X | ⊚ | ⊚ | ◯ | ⊚ | ◯ | Δ |
| Comparative Example 7 | XX | XX | XX | X | XX | XX | ◯ | X | X |
| Comparative Example 8 | XX | XX | XX | X | XX | XX | ⊚ | ⊚ | ⊚ |
| Comparative Example 9 | XX | XX | XX | X | XX | XX | ◯ | X | X |

Examples 1 to 11 are examples of molded products constituted by resin layer 1 alone, while Examples 12 to 17 are examples of molded products constituted by resin layer 1 (50 μm in thickness) and resin layer 2 (50 μm in thickness) overlaid to a total thickness of 100 μm.

According to the results of Examples 1 to 17, where the average particle size of ammonium salt of carboxylic acid was 20 μm or larger, sufficient anticorrosive property was realized over a medium term (3 days) on all iron castings, steel sheets, and galvanized steel sheets. Additionally, anticorrosive property was realized over a longer period of time (7 days) on iron castings and galvanized steel sheets when 6 parts by weight of ammonium benzoate were compounded into 100 parts by weight of resin layer 1, according to Example 4, and also when the thickness of resin layer 1 was 200 μm, as evident from the result of Example 8.

According to Example 12, where a resin layer whose composition was the same as that of resin layer 1 in Example 2 was formed to a thickness of 50 μm and resin layer 2 was also provided, superior longer-term anticorrosive property was achieved.

Furthermore, excellent long-term anticorrosive property was achieved on all iron castings, steel sheets, and galvanized steel sheets when both sodium sebacate and sodium nitrite were used in resin layer 2.

1. A resin molded product having a resin layer 1 that contains an ammonium salt of carboxylic acid with an average particle size of 20 μm or larger.

2. The resin molded product according to claim 1, wherein the resin layer 1 contains a metal salt of carboxylic acid.

3. The resin molded product according to claim 1, wherein the resin layer 1 contains one or more types of substances selected from carboxylic acid, benzotriazole-based compound, and tolyltriazole-based compound.

4. The resin molded product according to claim 1, which is further overlaid with a base material layer.

5. The resin molded product according to claim 4, wherein the base material layer contains one or more types of substances selected from metal salt of nitrous acid, carboxylic acid, benzotriazole-based compound, tolyltriazole-based compound, and metal salt of carboxylic acid.

6. The resin molded product according to claim 1, which is a sheet-like object or bag-like object.

7. The resin molded product according to claim 2, wherein the resin layer 1 contains one or more types of substances selected from carboxylic acid, benzotriazole-based compound, and tolyltriazole-based compound.

8. The resin molded product according to claim 2, which is further overlaid with a base material layer.

9. The resin molded product according to claim 2, which is a sheet-like object or bag-like object.

10. The resin molded product according to claim 3, which is further overlaid with a base material layer.

11. The resin molded product according to claim 3, which is a sheet-like object or bag-like object.

12. The resin molded product according to claim 4, which is a sheet-like object or bag-like object.

13. The resin molded product according to claim 5, which is a sheet-like object or bag-like object.

14. The resin molded product according to claim 7, which is further overlaid with a base material layer.

15. The resin molded product according to claim 8, which is a sheet-like object or bag-like object.

16. The resin molded product according to claim 10, which is a sheet-like object or bag-like object.

17. The resin molded product according to claim 14, which is a sheet-like object or bag-like object.

18. The resin molded product according to claim 8, wherein the base material layer contains one or more types of substances selected from metal salt of nitrous acid, carboxylic acid, benzotriazole-based compound, tolyltriazole-based compound, and metal salt of carboxylic acid.

19. The resin molded product according to claim 10, wherein the base material layer contains one or more types of substances selected from metal salt of nitrous acid, carboxylic acid, benzotriazole-based compound, tolyltriazole-based compound, and metal salt of carboxylic acid.

20. The resin molded product according to claim 14, wherein the base material layer contains one or more types of substances selected from metal salt of nitrous acid, carboxylic acid, benzotriazole-based compound, tolyltriazole-based compound, and metal salt of carboxylic acid.
